(19) United States
(12) Patent Application Publication
(10) Pub. No.: US 2009/0132583 A1
(43) Pub. Date: May 21, 2009

(54) SYSTEM AND METHOD FOR CAPTURING, ANNOTATING, AND LINKING MEDIA

(75) Inventors: Scott CARTER, Los Altos, CA (US); Laurent Denoue, Palo Alto, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/941,874

(22) Filed: Nov. 16, 2007

(51) Int. Cl. G06F 17/00

(52) U.S. Cl. 707/104.1; 707/E17.143

(57) ABSTRACT

A system and method for linking media that is captured and then classified based on a set of parameters, such that related media is linked for further analysis by a user. The parameters include temporal, proximity, and content information in the form of metadata that is extracted from each media clip received in the system. The linked media provides for complex analysis of collaboratively-captured media from multiple sources and the sharing of related media between users. The system further links annotations included with captured media to provide analysis of collaboratively-annotated media and aid users in accessing and synthesizing large amounts of collaboratively-captured media.

### BACKGROUND OF THE INVENTION

1. Field of the Invention

The present invention generally relates to systems and methods for capturing, annotating, and linking media, and more specifically to the use of temporal, proximity, and content features to link media captured on a variety of devices for further analysis.

2. Background of the Invention

People are capturing increasing amounts of multimedia data using an increasing diversity of mobile devices. However, tools to organize and synthesize this data are scarce. In some cases, synthesis of data is not that important and using simple streams will suffice, as with informal sharing of digital photos over the Internet. For many other tasks, though, it is vital to be able to structure media to tell a coherent story. For collaboratively captured media, such as that captured independently by a group of people using a variety of devices, data related to the media must be synthesized over not only a group of devices but also groups of users. Synthesizing such a large amount of data can be so difficult that much of the captured media may not be easily accessed at a later time.

Erol and Hull describe a system for indexing images captured with a camera phone into a presentation, see Berna Erol and Jonathan J. Hull, Linking presentation documents using image analysis, Asilomar Conference, 97-101 (2003). The access interface in Erol and Hull displays an original captured slide and a video recording at the time it was presented. A similar system using scanned images appears in a work by Patrick Chiu, Jonathan Foote, Andreas Girgensohn, and John Boreczky, Automatically Linking Multimedia Meeting Documents by Image Matching, Conference on Hypertext and Hypermedia, 244-245 (2000). Fink et al. describes a system that senses TV audio to automatically recognize the TV program that the user is currently watching, see Michael Fink, Michele Covell, and Shumeet Baluja, Social- and Interactive-Television Applications Based on Real-Time Ambient-Audio Identification, EuroITV (2006). Fink et al. use this technology to support social viewing applications. However, the aforementioned systems do not address collaboratively recorded media; they are not particularly designed for field settings; and they are designed primarily for retrieval of media, rather than media organization and synthesis.

Finally, a variety of systems disclose linked digital and paper documents. Yeh et al. developed ButterflyNet, a mobile capture and access system that integrates paper notes with photos captured in the field and includes some automatic linking capabilities, see Ron B. Yeh, Chunyuan Liao, Scott R. Klemmer, Fracois Guimbretiere, Brian Lee, Boyko Kakaradov, Jeannie Stamberger, and Andreas Paepcke, ButterflyNet: A Mobile Capture and Access System for Field Biology Research, CHI. 571-580 (2006). In Yeh, various data from different sensors are all linked temporally. Furthermore, a user can link photos to written text using a combination of gestures and temporal data, and can link photos and annotations using a visual tag.

Graham and Hull developed Video Paper, a paper-based method for retrieving video segments. Jamey Graham and Jonathan J. Hull, Video Paper: A Paper-Based Interface for Skimming and Watching Video, ICCE, 214-215 (2002). In Graham and Hull, a video's transcript is annotated with barcodes that jump to corresponding positions in the video. A remote control device reads the barcodes to control the replay of the video. However, these paper-based works do not attempt to link digital documents gathered synchronously by multiple individuals. Additionally, they also do not utilize context meta-data to generate links between and within documents.

Thus, the conventional technology fails to provide a system and method for capturing and organizing media and its relevant data for improved synthesis and analysis of related content. Also, the current state of the art lacks a system for organizing and synthesizing media captured by remote devices.

### SUMMARY OF THE INVENTION

The inventive methodology is directed to methods and systems that substantially obviate one or more of the above and other problems associated with conventional techniques for capturing, classifying and linking collaboratively-captured media.

In accordance with one aspect of the inventive methodology, there is provided a system, which uses a combination of proximity, temporal and content information to establish links between related media. The system facilitates for complex analysis of collaboratively-captured media from multiple sources and the sharing of related media between users. The system further links annotations included with captured media to provide analysis of collaboratively-annotated media and aid users in accessing and synthesizing large amounts of collaboratively-captured media.

In accordance with another aspect of the methodology, there is provided a system for linking media comprising a media-capture server for receiving media clips and other parameters from a plurality of sources, wherein the parameters include time information, proximity information and content information of the media-clips, and wherein the media-capture server is further able to receive annotations corresponding to the media clips; a media classifier for classifying the media clips based on at least one parameter; and a media linker for linking related media clips based upon the at least one parameter.

In another aspect of the inventive methodology, the media linker is further operable to link annotations with related media clips.

In a further aspect of the inventive methodology, the system further comprises a display interface unit, operable to cause the linked related media clips to be displayed to a user.

In still another aspect of the inventive methodology, the media clip is selected from a group consisting of video, audio, and a picture.

In a yet further aspect of the inventive methodology, the time information parameter correlates the time of the recording of each related media clip.

In another aspect of the inventive methodology, the proximity information parameter determines the physical proximity between sources at the time the media is captured.

In a further aspect of the inventive methodology, the proximity information is determined using a Bluetooth connection between the sources that captured the media clips.

In still another aspect of the inventive methodology, the content information parameter includes audio metadata.

In a yet further aspect of the inventive methodology, the content information includes video metadata.

In accordance with one aspect of the inventive methodology, there is provided a method for linking media comprising the steps of receiving media clips and other parameters from a plurality of sources, wherein the parameters include time information, proximity information and content information of the media-clips, and further receiving annotations corresponding to the media clips; classifying the media clips based on at least one parameter; and linking related media clips based upon the at least one parameter.

In another aspect of the inventive methodology, the method further comprises linking annotations corresponding to the media clips with related media clips.

In a further aspect of the inventive methodology, the method further comprises displaying the linked related media clips to a user.

In still another aspect of the inventive methodology, the media clip is selected from a group consisting of video, audio, or a picture.

In a yet further aspect of the inventive methodology, the time information parameter correlates the time of the recording of each related media clip.

In another aspect of the inventive methodology, the proximity information parameter determines the physical proximity between sources at the time the media is captured.

In a further aspect of the inventive methodology, the proximity information parameter is determined using a Bluetooth connection between the sources that captured the media clips.

In still another aspect of the inventive methodology, the content information parameter includes audio metadata.

In a yet further aspect of the inventive methodology, the content information parameter includes video metadata.

In another aspect of the inventive methodology, a computer program product comprising a set of instructions embodied on a computer-readable medium for linking media comprising the set of instructions, when executed by one or more processors causing the one or more processors to perform a method comprising receiving media clips and other parameters from a plurality of sources, wherein the parameters include time information, proximity information and content information of the media-clips, and wherein the media-capture server is further able to receive annotations corresponding to the media clips; classifying the media clips based on at least one parameter; linking related media clips based upon the at least one parameter; outputting a graphical user interface of the linked media clips to a user.

In another aspect of the inventive methodology, the computer program product further comprises linking annotations corresponding to the media clips with related media clips.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 depicts an exemplary embodiment of an architecture for a system for capturing and linking media, according to one aspect of the invention;

FIG. 2 is an illustration of an exemplary embodiment of a graphical user interface for displaying linked media, according to one aspect of the invention;

FIG. 3 depicts an exemplary architecture for a system for capturing linked media, according to one aspect of the invention;

FIG. 4 depicts one illustration of media content that an embodiment of the inventive system links between two users;

FIG. 5 is an exemplary block diagram depicting a method of capturing, classifying, and linking collaboratively-captured media, according to one aspect of the invention; and

FIG. 6 illustrates an exemplary embodiment of a computer platform upon which the inventive system may be implemented.

### DETAILED DESCRIPTION OF THE INVENTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

One or more embodiments of the present invention relate to systems and methods for establishing automatic links between media, and particularly for linking collaboratively-captured media to provide for further analysis. In one aspect, an embodiment of the inventive system uses a combination of proximity, temporal and content parameters to automatically establish links between different media, such as media captured from multiple sources at a single event. The embodiment of the system is also capable of establishing links between annotated media, such as linking annotations made to representations of documents with the original documents themselves. The linking of annotated media allows for complex analysis of collaboratively-annotated media and aids users in accessing and synthesizing large amounts of collaboratively-captured media.

An embodiment of the inventive system uses data captured at the time of recording to correlate media clips and connect related media clips to its original content. The use of proximity, temporal, and content parameters provides sufficient classification of captured media to eliminate ambiguous or non-related references and link only relevant media and annotation information.

In one aspect, media sources such as mobile devices that directly capture media, such as video cameras, digital cameras, cell phones and voice recorders run the system software and can immediately classify and link captured media, which can then be shared with other devices for analysis, editing and annotation on-the-fly. In this sense, an embodiment of the system facilitates organizing and synthesizing media captured in the field.

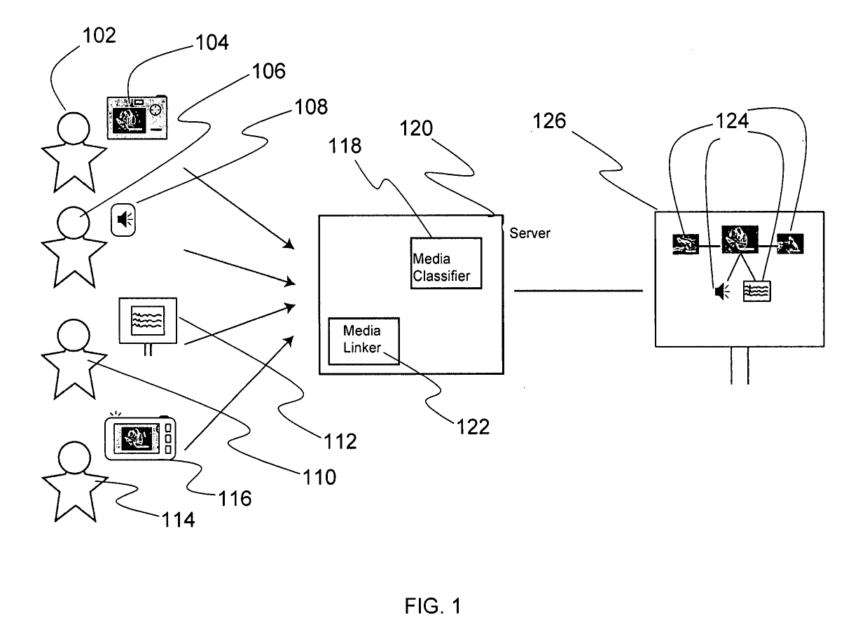

In one non-limiting example, illustrated in FIG. 1, media is captured from a variety of mobile devices, which are contemporaneously present and operable to capture various aspects of the same event or a sequence of events. It would be appreciated by those of skill in the art that the inventive concept is not limited to only mobile devices. Any other types of media capture devices may be used as well. For example, multiple users may be attending a press conference and using a variety of mobile or stationary devices to capture media clips. In the exemplary embodiment shown in FIG. 1, a first user 102 is recording video 104, a second user 106 is recording audio 108, a third user 110 is taking notes 112 on a computer, and a fourth user 114 is taking pictures 116. As all the users collaboratively capture media clips by recording information from the event or taking notes on the event details, a media classifier 118, running on each device or at a media-capture server 120, is classifying the media based on the time that each media clip is being captured, the proximity of devices to one another, and the actual content of the media clips, such as audio and image data. The classified media clips are then uploaded to the media-capture server 120 and compared with one another and even with other media clips already loaded into the server. A media linker 122 then links related media clips 124 depending on the degree and/or nature of the relationship of the clips to one another. A user can then view a display 126 of the related media clips 120 and analyze all of the media captured during the event to better synthesize and understand the various media captured by different users.

In an additional embodiment, the inventive system enables the users, apart from the third user 110 taking notes 112 on the computer, to make annotations to any type of media being captured, such as by adding audio commentary to their audio or video recording, or by writing notes on or next to a captured image. These annotations are also classified by an embodiment if the inventive system and linked with related media clips or other annotations, so that a user can analyze all of the annotations made by users capturing media content during an event.

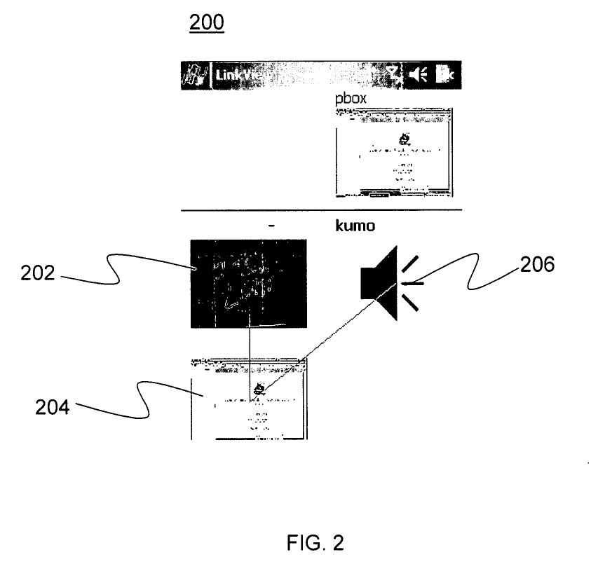

FIG. 2 illustrates one aspect of an exemplary user interface 200 that displays the linked related media clips of a meeting. In this particular non-limiting example, a hand-written note 202 is linked with a presentation 204, and the presentation 204 is also linked with an audio recording 206, which could include comments made by a participant at the meeting at some point during the presentation 204. As described above with reference to FIG. 1, the system classifies the captured media and then links the media based on certain factors, such as proximity. In this aspect, the note 202, presentation 204, and audio recording 206 are all linked together because they all originated in the same location, the “kumo” meeting room, at the same time. Once the system links the captured, classified media, the linked media is displayed in a user interface 200 such as the one shown in FIG. 2.

The system may be partially embodied as a software product running on each device so that classification and linking of the media and annotations can be performed instantaneously, or the system can be run on a separate computer or remote server where the media content is loaded at a later time and synchronized with the system for classification and linking.

The system structures captured media by creating links based on proximity, temporal and content parameters gathered from metadata that is extracted from each media clip. To create proximity-based links, in one aspect of the invention, a mobile device continuously records audio as well as the Bluetooth identities of nearby devices. It should be noted that the inventive system is not limited only to Bluetooth networking protocol and any other suitable networking technology that provides for identity discovery may also be used. When a user creates a recording, the contextual metadata, including, for example, the Bluetooth identity information, is saved on a server with the original recording. When media from other devices is synchronized with the server, the system automatically connects recordings with nearby Bluetooth identities. In one exemplary embodiment, the aforesaid aspect of the inventive system may be implemented in a similar manner to a software system distributed by In the Hand Ltd. (http://32feet.net). This software system uses Bluetooth connections to link devices. The proximity information helps limit the captured media to that which is relevant to the press conference. Because the inventive system may enable linking of media from any user or any media source, the aforesaid proximity information is designed to prevent media captured at a simultaneous, but different press conference taking place in another location from being linked with the media at the press conference that is being attended by the users. Proximity information could be determined instantaneously during media capture through the use of location devices such as Global Positioning Satellite (“GPS”) receivers. In another embodiment, the proximity information is determined relative to other users, using, for example, the features of the Bluetooth connections that communicate with and uniquely identify each device present at the press conference.

Temporal information can include data on the exact time when the content was captured, including the moment when an annotation has been made by the user taking notes. The temporal information helps the system synchronize the collaboratively-captured media so that the variety of media content can be viewed in a manner that is relevant and easily understood by someone doing analysis of all of the collaboratively-captured media. Temporal information is embedded in most standard media formats (EXIF metadata). Libraries exist for extracting this information at http://www.sno.phy.queensu.ca/˜phil/exiftool/.

Content information can include audio and image data collected by the relevant devices. This includes image-based features such as color or motion that can be extracted as metadata and compared with metadata from other captured media. Existing software can be used to extract the metadata features from the media, such as The OpenCV library provides a host of functions that can extract this data (http://www.intel.com technology/computing/opencv/index.htm).

Additionally, extracted optical character recognition (OCR) text from pictures or video can be saved as meta-content and linked with other data uploaded to the server. An embodiment of the inventive system may also search for similar audio clips in any video recordings and link the clips to similar segments. In combination, these features allow users to seamlessly connect media captured by their device to media captured by devices that are not directly connected to the system or running the system software.

An embodiment of the inventive system makes available key frames of videos as they are recorded, as well as thumbnails of the most recent photo and audio clips taken. Nearby users can grab these thumbnails to organize or annotate media. The inventive system software will also allow users to mark a particularly interesting point-in-time and automatically retrieve representations of the latest captured content on nearby devices.

In a further aspect of the invention, an embodiment of the inventive system allows users to collect, annotate, and organize representations of digital media that will be substituted with their original content when it becomes available.

In one aspect, the inventive system uses implicitly-gathered Bluetooth and audio data, as well as image-based content, to link representations of media captured on a mobile device with the original media captured on other digital media recording platforms. The system also allows users to annotate representations of media on-the-fly on mobile devices and automatically link the annotations to the original media when the data is synchronized. Furthermore, the system links annotations of representations of temporal media, such as video, to the point-in-time when the representation was captured. The system is also capable of allowing devices to share representations of media with other peer devices for on-the-fly annotation and editing.

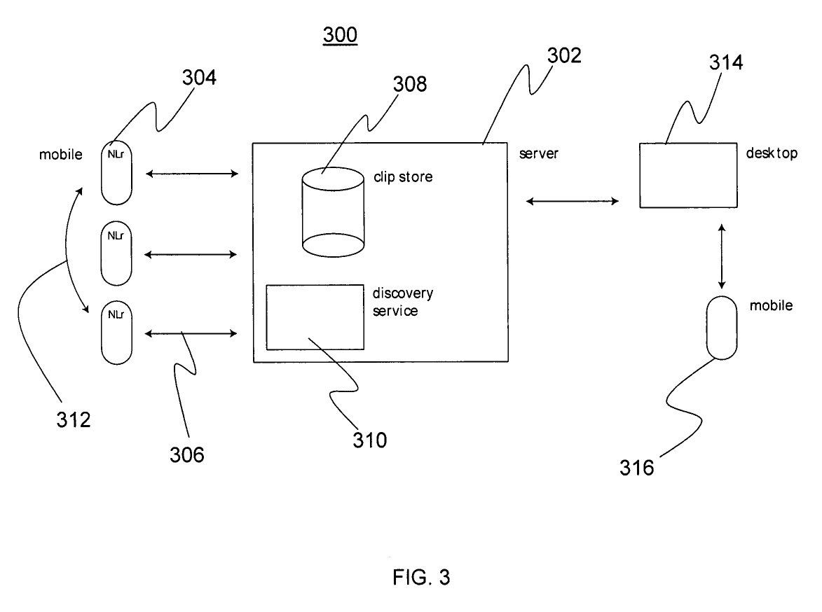

In one aspect of the invention set forth in FIG. 3, the architecture of the system 300 includes both a media-capture server 302 and at least one mobile device 304 running the system software. The mobile application 304 can capture a wide variety of media, such as video, image and audio data, as well as sensor-data such as Bluetooth proximity information. The mobile device 304 also includes a user interface (“UI”) (not shown) to organize and annotate media stored on the device itself.

In one embodiment, mobile devices enabled with inventive system software display clip representations locally while uploading 306 full clips to the media-capture server 302 and then to a remote database, described as a clip store 308 where users can browse and search for related media clips. In the aspect depicted in FIG. 3, a discovery service 310 is provided within the server to expose the IP addresses of various mobile devices 304 to other devices so that they can be found by each other. Users may therefore manually synchronize data 312 with other mobile devices 304. The media-capture server 302 automatically links clips with manually-synchronized clips. The server 302 can also receive data from other devices not running the system software through a desktop computer 314. In one aspect, a non-system mobile device 316 that is not running the inventive system software can still upload content to the desktop computer 314, which will then upload the content to the media-capture server 302 through a webpage or other interface connection to be classified and linked by the inventive system.

In another non-limiting illustration of an operation of an embodiment of an inventive system, Bob, a user, desires to make a text annotation of a segment of a video that Marcia is recording on a standard Bluetooth-enabled digital video device. In this situation, Bob will necessarily be near Marcia, because he is commenting on something that she is recording. Bob can use his mobile device to enter his comments. Behind-the-scenes, the embodiment of the inventive system will automatically send his comment to the server along with a clip of 15-seconds of audio recorded before and after his comment, as well as a snapshot containing information on all of the nearby Bluetooth devices. Later, when Marcia uploads her recorded video, the system will use the audio and the Bluetooth data to link Bob's comment to the correct device as well as the correct sequence of video that Bob was annotating. Note that links would have been created for any type of media, such as a picture taken by Bob or his own video recording.

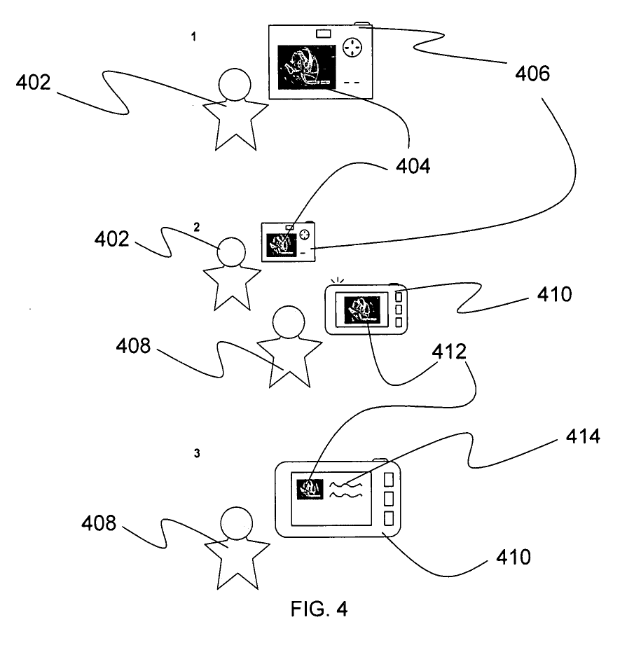

In another non-limiting example illustrated in FIG. 4, Marcia 402 is shooting a video clip 404 of a scene with her digital recording device 406. Bob 408 takes a picture of the view port of Marcia's recording device 406 with his own digital camera 410, capturing an image 412 of the video clip 404 being shot by Marcia 402. Bob 408 can then make annotations 414 on the image 412, which will be automatically linked to the original video clip 404 when Marcia 402 synchronizes her device 406 with the system.

In another aspect, Bob 408 could also take a photo 412 of the view port of Marcia's video recording device 406 just before or after he makes his annotation 414. This action links Bob's annotation 414 to a particular key frame in Marcia's video clip 404. Immediately after making the annotation 414, Bob 408 sees on his device 410 the picture he took of Marcia's recording 404 with the annotation 414 already linked. Later, when Marcia 402 synchronizes her video, Bob's picture 412 will become an active link into the source video clip 404. Bob can use this method to create collections of media on the fly that are combinations of original recordings he has made as well as pointers to recordings others have made. He can organize these clips on his own device immediately, and all of the linking will occur post hoc.

In an alternative embodiment, Bob could also mark an interesting point-in-time of Marcia's video clip 404 by pressing a button and, if Marcia is using a device running the system software, Bob could automatically retrieve the latest key frame from Marcia's recording and add that key frame to his own collection. If the device is not running the system software, the captured media can be uploaded to the system and classified by an instance of the system running on the user's local computer or a remote server. In this embodiment, annotations on representations of temporal media, in this case video, is linked to the corresponding time point when the representation was captured.

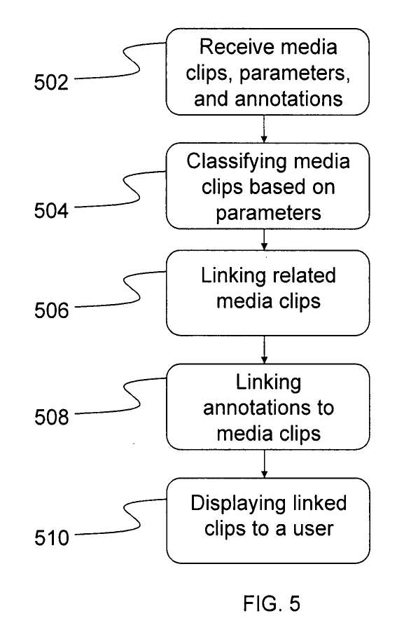

An exemplary implementation of a method for linking media is illustrated in FIG. 5, where the first step 502 involves receiving media clips, parameters and annotations corresponding to the media clips. The aforesaid media clips and parameters can be captured and received from a variety of sources. In a second step 504, the captured media is classified based on at least one parameter. Once the media is classified, the system links the related media clips in step 506. The system is further able to link annotations to related media clips in step 508. Finally, the linked media is displayed to a user in step 510.

Various aspects of the present invention, whether alone or in combination with other aspects of the invention, may be implemented in C++ code running on a computing platform operating in a LSB 2.0 Linux environment. However, aspects of the invention provided herein may be implemented in other programming languages adapted to operate in other operating system environments. Further, methodologies may be implemented in any type of computing platform, including but not limited to, personal computers, mini-computers, main-frames, workstations, networked or distributed computing environments, computer platforms separate, integral to, or in communication with charged particle tools, and the like. Further, aspects of the present invention may be implemented in machine readable code provided in any memory medium, whether removable or integral to the computing platform, such as a hard disc, optical read and/or write storage mediums, RAM, ROM, and the like. Moreover, machine readable code, or portions thereof, may be transmitted over a wired or wireless network.

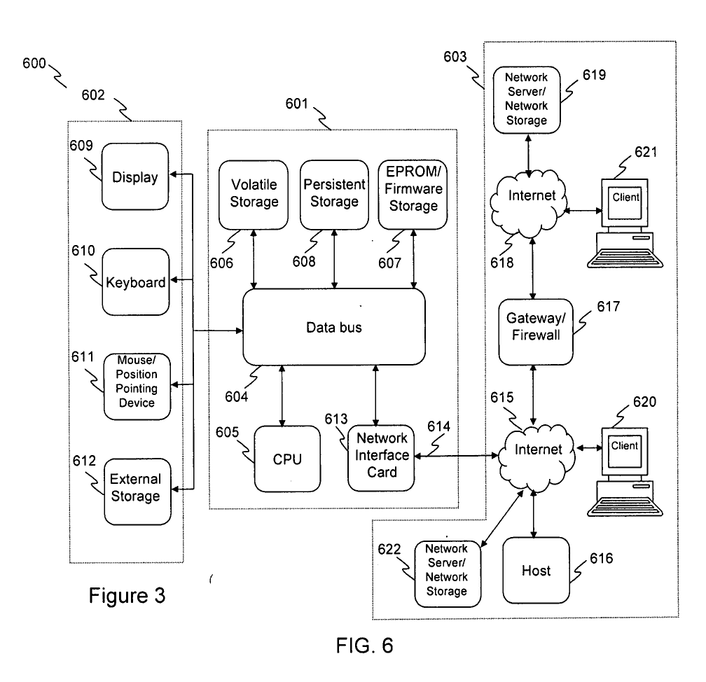

FIG. 6 is a block diagram that illustrates an embodiment of a computer/server system 600 upon which an embodiment of the inventive methodology may be implemented. The system 600 includes a computer/server platform 601, peripheral devices 602 and network resources 603.

The computer platform 601 may include a data bus 604 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 604 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 604 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 604 to a display 609, such as a cathode ray tube (CRT), plasma display, or a liquid crystal display (LCD), for displaying information to a system administrator or user of the computer platform 601. An input device 620, including alphanumeric and other keys, is coupled to bus 601 for communicating information and command selections to processor 605. Another type of user input device is cursor control device 611, such as a mouse, a trackball, or cursor direction keys for communicating direction information and command selections to processor 604 and for controlling cursor movement on display 609. This input device typically has two degrees of freedom in two axes, a first axis (e.g., x) and a second axis (e.g., y), that allows the device to specify positions in a plane.

An external storage device 612 may be connected to the computer platform 601 via bus 604 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 608. Volatile media includes dynamic memory, such as volatile storage 606. Transmission media includes coaxial cables, copper wire and fiber optics, including the wires that comprise data bus 604. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on the data bus 604. The bus 604 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 604. Communication interface 613 provides a two-way data communication coupling to a network link 614 that is connected to a local network 615. For example, communication interface 613 may be an integrated services digital network (ISDN) card or a modem to provide a data communication connection to a corresponding type of telephone line. As another example, communication interface 613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 614 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients 620 and 621 may themselves be implemented based on the computer platform similar to the platform 601.

Local network 615 and the Internet 618 both use electrical, electromagnetic or optical signals that carry digital data streams. The signals through the various networks and the signals on network link 614 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 614 and communication interface 613. In the Internet example, when the system 601 acts as a network server, it might transmit a requested code or data for an application program running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution. In this manner, computer system 601 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the computerized storage system for capturing, classifying and linking collaboratively-captured media. It is intended that all matter contained in the above description or shown in the accompanying drawings shall be interpreted as illustrative only and not limiting.

What is claimed is:

1. A system for linking media comprising:
a media-capture server operable to receive media clips and parameters from a plurality of sources, wherein the parameters comprise time information, proximity information and content information of the media-clips, and wherein the media-capture server is further operable to receive annotations corresponding to the media clips;
a media classifier operable to classify the media clips based on at least one parameter; and
a media linker operable to link related media clips based upon the at least one parameter.

2. The system of claim 1, wherein the media linker is further operable to link the annotations with related media clips.

3. The system of claim 1, further comprising a display interface unit, operable to cause the linked related media clips to be displayed to a user.

4. The system of claim 1, wherein the media clip is selected from a group consisting of video, audio, and a picture.

5. The system of claim 1, wherein the time information parameter correlates the time of recording of each related media clip.

6. The system of claim 1, wherein the proximity information parameter determines the physical proximity between sources at a time the media is captured.

7. The system of claim 6, wherein the proximity information is determined using a Bluetooth connection between the plurality of sources capturing the media clips.

8. The system of claim 1, wherein the content information parameter comprises audio metadata.

9. The system of claim 1, wherein the content information comprises video metadata.

10. A method for linking media comprising:
receiving media clips and other parameters from a plurality of sources, wherein the parameters comprise time information, proximity information and content information of the media-clips, and further receiving annotations corresponding to the media clips;
classifying the media clips based on at least one parameter; and
linking related media clips based upon the at least one parameter.

11. The method of claim 10, further comprising linking annotations corresponding to the media clips with related media clips.

12. The method of claim 10, further comprising displaying the linked related media clips to a user.

13. The method of claim 10, wherein the media clip is selected from a group consisting of video, audio, or a picture.

14. The method of claim 10, wherein the time information parameter correlates the time of the recording of each related media clip.

15. The method of claim 10, wherein the proximity information parameter determines the physical proximity between sources at the time the media is captured.

16. The method of claim 15, wherein the proximity information parameter is determined using a Bluetooth connection between the plurality of sources capturing the media clips.

17. The method of claim 10, wherein the content information parameter comprises audio metadata.

18. The method of claim 10, wherein the content information parameter comprises video metadata.

19. A computer programming product, embodied on a computer-readable medium, comprising a set of instructions for linking media, the set of instructions, when executed by one or more processors causing the one or more processors to:
receive media clips and other parameters from a plurality of sources, wherein the parameters comprise time information, proximity information and content information of the media-clips, and wherein the media-capture server is further able to receive annotations corresponding to the media clips;
classify the media clips based on at least one parameter;
link related media clips based upon the at least one parameter; and
output a visual representation of the linked media clips to a user.

20. The computer program product of claim 19, wherein the set of instructions further causes the one or more processors to link annotations corresponding to the media clips with related media clips.
